(19) United States
(12) Patent Application Publication
(10) Pub. No.: US 2007/0130480 A1
(43) Pub. Date: Jun. 7, 2007

(54) System and method for enabling fast power-on times when using a large operating system to control an instrumentation system

(76) Inventors: Gregory S. Hill, Santa Rose, CA (US); Dennis M. Nishi, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/294,981

(22) Filed: Dec. 6, 2005

(51) Int. Cl. G06F 1/26

(52) U.S. Cl. 713/300

(57) ABSTRACT

An instant-on instrument system is achieved by having the operating system boot completely when power is first applied to the instrument system, but when the system is still in the off mode. The OS brings the instrument system to the point where all internal checks have been accomplished but does not turn on anything externally detectable functions, such as the display, the display backlight and the fan. Once the OS has booted, the hard drive is stopped, the clock rate is reduced, power is removed from any measurement PC cards. At this point the instrument system is essentially in a “sleep” mode. When a user turns the instrument system on, the clock rate picks up, and all other functions come alive for the duration of the testing cycle. When the user turns the instrument system off, the system reboots and then returns to the sleep mode once again. From the user's perspective, the testing system operates essentially as in instant-on system even though it is controlled by a large operating system having an inherently long boot-up time.

### FIELD OF THE INVENTION

This invention relates to instrumentation systems and more particularly to such systems in which a large operating system is used for controlling the instrumentation system and even more particularly to a system in which the power-on time is not delayed by the booting requirements of the operating system.

### BACKGROUND OF THE INVENTION

Instrumentation systems have increasingly started to use their own operating systems for controlling the operation of the system. This has a drawback in that portability of applications from one instrument system to another is not as straightforward as one would like due to the differences of the operating systems for the different instrument systems. One solution to this problem is to use a common operating system (OS) which will enhance the portability of applications across instrument systems. The selected OS must then be large and fully featured in order to accommodate a wide variety of applications and instrument systems. However, large OSs have relatively long start-up times which then results in a large, and unacceptable, power-on delay times.

One solution to the start-up delay problem is to store the OS in a high-speed flash memory instead of in a hard disk. The flash memory approach, while reducing the memory boot-up time, is more expensive than the hard drive approach and still suffers from some amount of start-up delay time while the OS is going through its various BIOS, memory initialization, device loading and other system checks.

### BRIEF SUMMARY OF THE INVENTION

An instant-on instrument system is achieved by having the operating system boot completely when power is first applied to the instrument system while the system is still in the off mode. The OS brings the instrument system to the point where all internal checks have been accomplished but does not turn on any externally detectable functions, such as the display and the display backlight at this time, the fan is running at a reduced speed, if at all. Once the OS has booted, the hard drive is stopped, the clock rate is reduced and power is removed from any measurement PC cards. At this point the instrument system is essentially in a “sleep” mode. When a user turns the instrument system on, the clock rate picks up and all other functions come alive for the duration of the user session. When the user turns the instrument system off, the system reboots and then goes into the sleep mode once again. From the user's perspective, the testing system operates essentially as in instant-on system even though it is controlled by a large operating system having an inherently long boot-up time.

### BRIEF DESCRIPTION OF THE DRAWINGS

For a more complete understanding of the present invention, reference is now made to the following descriptions taken in conjunction with the accompanying drawings, in which:

FIG. 1 is a flow chart of one embodiment of a fast power-on instrumentation system;

FIG. 2a is a table illustrating for one embodiment the multiple states the processor subsystem may have when the power switch is on or off;

FIG. 2b is a table enumerating for one embodiment a typical processor subsystem transitions that occur due to toggling the power switch;

FIG. 3 is a simplified diagram of some components that may be found in a measurement instrument; and

FIG. 4 is a flow chart illustrating the boot procedure for a large operating system.

### DETAILED DESCRIPTION OF THE INVENTION

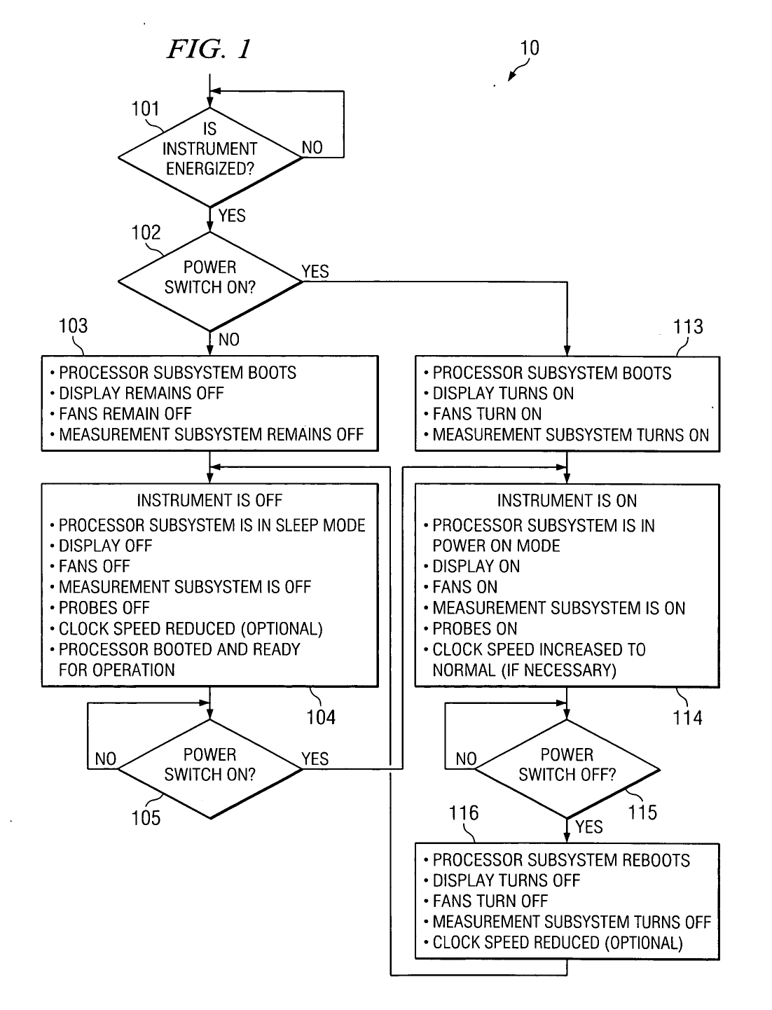

FIG. 1 shows flow chart 10 of one embodiment of a fast power-on instrumentation system. Process 101 determines when an instrument such as instrument 30, FIG. 3, is energized. Process 102 determines if the power switch (such as switch 307, FIG. 3) is on. If the power switch is not on, (meaning that measurements are not about to be made at this time) the processor subsystem begins its boot process 103 leaving the display, and measurement subsystem, etc off. The fan may be off, but most likely it will be running at a reduced speed. After the boot process has finished, the processor subsystem will go into the sleep state leaving the display, and measurement subsystems off and the instrument is considered by the user to be off as shown by process 104. Note that while the system appears to be off to the user, the processor is running in a booted manner.

When the power switch is turned on, as determined by process 105, (meaning that it is desired to make measurements) the processor subsystem will transition from the sleep state (process 104) to the power-on state (process 114) and the clock, display, fans, and measurement subsystems will turn on, the clock will increase to its normal speed (if it had been running at a reduced speed) and the instrument is considered to be available for use almost immediately without waiting for the boot-up operation to be performed.

If the on-off instrument switch (307, FIG. 3) had been in the on position when process 102 checked, the processor subsystem will begin its full boot process and the display, fans, and measurement subsystem will turn on, as controlled by processes 113 and 114.

After the instrument has been in the on mode (process 114) and process 115 determines that the power switch is turned off, the processor subsystem reboots and the display, fans, measurement subsystem are turned off and the clock slowed as controlled by process 116. After reboot process 116 has finished, the processor subsystem goes into the sleep state (process 104) and the instrument is considered to be off.

It is noted that alternative embodiments may have different methods for the processor subsystem rebooting of reboot process 116, which may include, but are not limited to: a warm reboot, wherein the processor subsystem maintains power and simply restarts the OS; a cold reboot, wherein power is removed from the processor subsystem, power is restored to the processor subsystem, and the OS is started; or a combination wherein the OS is shut down, power is removed from the processor subsystem, power is restored to the processor subsystem, and the OS started.

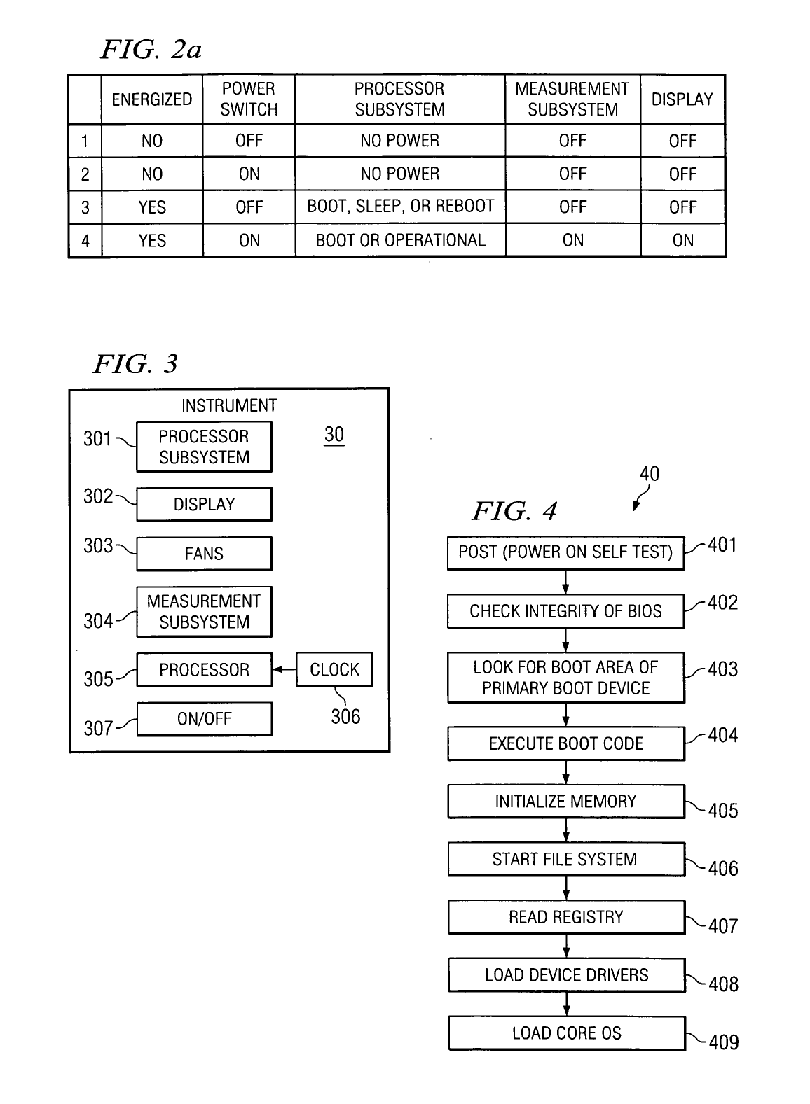

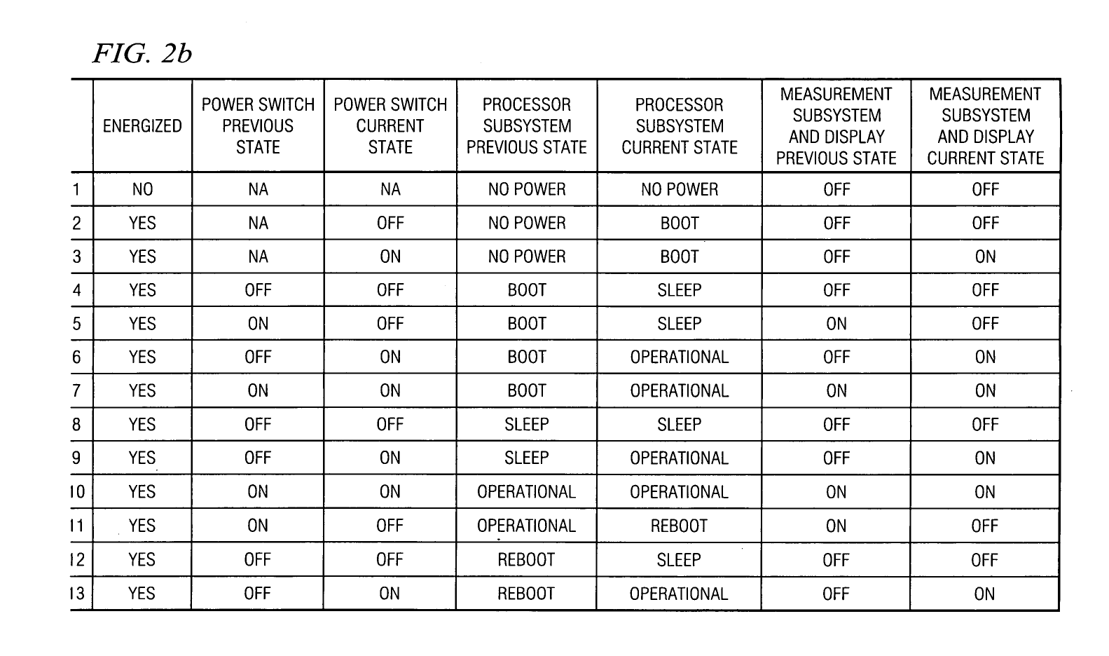

FIG. 2a is a table illustrating for one embodiment the multiple states the processor subsystem may have when the power switch is on or off. While the instrument is not energized, rows 1-2, the processor subsystem remains in the no power state with the measurement subsystem and display remaining off, waiting for process 105 to signal the beginning of a new testing sequence.

If the instrument is energized with the power switch off, row 3, then the processor subsystem may be in any one of the boot, sleep, or reboot states with the measurement subsystem and display being off.

If the instrument is energized with the power switch on, row 4, then the processor subsystem may be in either the boot or operational states with the measurement subsystem and display being on.

FIG. 2b is a table enumerating for one embodiment typical processor subsystem transitions that may occur due to toggling the power switch. While the instrument is not energized, row 1, the previous and current power switch states do not matter; the processor subsystem will remain in the no power state, and the measurement subsystem and display will remain off.

When the instrument is energized and the processor subsystem was in the no power state (rows 2-3) the processor subsystem will transition to the boot state, and if the power switch is on (row 3) the measurement subsystem, display and any other needed systems will turn on.

When the instrument is energized and the processor subsystem was in the boot state, the power switch was off and remains off (row 4), the processor subsystem will transition to the sleep state, and the measurement subsystem and display will remain off.

When the instrument is energized and the processor subsystem was in the boot state, the power switch was on and turns off (row 5), the processor subsystem will transition to the sleep state, and the measurement subsystem and display will turn off.

When the instrument is energized and the processor subsystem was in the boot state, the power switch was off and changes to on (row 6), the processor subsystem will transition to the operational state, and the measurement subsystem and display will turn on.

When the instrument is energized and the processor subsystem was in the boot state, the power switch was on and remains on (row 7), the processor subsystem will transition to the operational state, and the measurement subsystem and display will remain on.

When the instrument is energized and the processor subsystem was in the sleep state, the power switch was off and remains off (row 8), the processor subsystem will remain in the sleep state, and the measurement subsystem and display will remain off.

When the instrument is energized and the processor subsystem was in the sleep state, the power switch was off and turns on (row 9), the processor subsystem will transition to the operational state, and the measurement subsystem and display will turn on.

When the instrument is energized and the processor subsystem was in the power on state, the power switch was on and remains on (row 10), the processor subsystem will remain in the operational state, and the measurement subsystem and display will remain on.

When the instrument is energized and the processor subsystem was in the power on state, the power switch was on and turns off (row 11), the processor subsystem will transition to the reboot state, and the measurement subsystem and display will turn off.

When the instrument is energized and the processor subsystem was in the reboot state, the power switch was off and remains off (row 12), the processor subsystem will transition to the sleep state, and the measurement subsystem and display will remain off.

When the instrument is energized and the processor subsystem was in the reboot state, the power switch was off and turns on (row 13), the processor subsystem will transition to the operational state, and the measurement subsystem and display will turn on.

FIG. 3 is a simplified diagram of some components that may be found in a measurement instrument. Measurement instrument 30 may contain one or more each of processor subsystems 301, displays 302, fans 303, measurement subsystems 304, processors 305, clocks 306 and on/off switches 307.

Processor subsystems 301, which are controlled by processor 305 and clock 306, may have many states which may include: no power, boot, sleep, operational, and reboot. Processor subsystem 301 runs a large operating system, such as the Microsoft XP Pro operating system (OS). This OS may take as long as five minutes to boot after an “on” condition is detected, which is determined in part by the number and type of components in measurement instrument 30. In the no power state, the processor subsystem is not energized. In the boot state, the processor runs its boot process. In the sleep state the processor subsystem is energized but may not be running any active applications and may reduce its power consumption (i.e. reducing clock rates, shutting down hard drives, etc.).

In the operational state, the processor subsystem is ready for use by the measurement instrument as directed by the user. In the reboot state, the processor subsystem may run some or all of its boot process.

It is noted that processor subsystems may have many other states that may be used to either decrease the turn-on time of the instrument or to conserve power. Some processor subsystems may have multiple speed (or clock) states which may affect the power consumption of the processor subsystem. An alternative embodiment of the invention may have a low speed boot state for when the instrument is energized and the power switch is off and a high speed boot state for when the instrument is energized and the power switch is on. Similarly, there may also be high speed reboot and low speed reboot states.

FIG. 4 illustrates flow chart 40 showing the boot process for a large operating system (OS), such as the Microsoft XP Pro OS. As is apparent, the boot process 40 has many steps 401-409 that may increase the turn on time for the instrument. It is understood that different operating systems have different boot processes, which when used in a measurement instrument, increases the turn on time of the instrument. In the process shown, process 401 performs the power on self test (POST) ensuring that the minimal required hardware for the processor subsystem 301 is present and functioning properly. Process 402 checks the integrity of the BIOS. Process 403 looks for the boot area of the primary boot device. Process 404 executes the boot code from the boot area of the primary boot device. Process 405 initializes the memory. Process 406 starts the file system. Process 407 reads the registry. Process 408 loads the device drivers for the devices connected to and controlled by measurement instrument 30. Process 409 loads the core OS. After the completion of the boot process, additional applications may be started on processor subsystem 301 for the particular type of measurements measurement instrument 30 will be performing.

It is noted that alternative embodiments may use smaller operating systems. As an example, a portable measurement instrument, such as a handheld oscilloscope may use a smaller OS to conserve power. Such an oscilloscope may have a processor subsystem boot when power is initially applied (either via batteries or an electrical outlet) and then go into a hibernation mode, wherein the state of the OS is copied to a storage device after which the processor subsystem is turned off. When the power switch is turned on, the processor subsystem copies the state of the OS from the storage device, taking less time than the boot process. When the power switch is turned off, the system may reboot and then go into hibernation mode again.

What is claimed is:

1. A method for controlling an instrument system having therein an operating system (OS) having a relatively long boot-up time, said method comprising:
upon sensing a connection to a source of power, said OS performing its normal boot-up testing and loading operations while at the same time not turning on user observable functions;
upon completion of said testing and loading operations said OS going into a sleep mode; and
upon sensing a power-on command, said OS turning on user observable functions and allowing said instrument system to operate as designed in a relatively short period of time after said power-on command is sensed.

2. The method of claim 1 further comprising:
upon sensing a power-off command said OS returning said instrument system to said sleep mode.

3. The method of claim 2 wherein said sleep mode comprises maintaining system displays, fans, drives and instrument cards in their respective off states and reducing the system clock rate.

4. The method of claim 3 wherein said returning said instrument system to said sleep mode after said power-off sensing comprises:
turning said OS system off and then rebooting said system by performing its testing and loading operations while at the same time not turning on user observable functions; and
upon completion of said testing and loading operations said OS going into said sleep mode.

5. An instrumentation system comprising:
a full-featured operating system (OS) having a relatively long boot-up routine;
a display;
an on-off switch; a processor controlled, at least in part, by a clock, said processor running said OS;
a sensor for causing said OS to perform its boot routine when power is applied to said instrumentation system even though said instrumentation is in the off mode as controlled by said on-off switch;
control for allowing said boot-up routine to be completed while maintaining said display in its off position;
said control further operable when said boot-up routine is completed for reducing the speed of said clock; and
said control further operable when said instrumentation goes into the on mode as controlled by said on-off switch for increasing the speed of said clock to its normal speed and for turning on said display so that said instrumentation is available for use in a relatively short interval.

6. The system of claim 5 further comprising:
said control further operable when said instrumentation goes into the off mode as controlled by said on-off switch for decreasing the speed of said clock and for turning off said display.

7. The system of claim 5 further comprising:
said control further operable when said instrumentation goes into the off mode as controlled by said on-off switch for causing said OS to restart, performing said boot routine, turning off said display, and when said restart is completed for decreasing the speed of said clock.

8. The system of claim 5 further comprising:
said control further operable during said boot-up routine for turning on said display when said on-off switch is on and turning off said display when said on-off switch is off.

9. The system of claim 5 further comprising:
said control further operable during said boot-up routine for changing said speed of said clock to its normal speed when said on-off switch is on and changing said speed of said clock to a low speed when said on-off switch is off.

10. A measurement instrument comprising:
at least one processor having an energized state and a measurement state;
means for maintaining all user functions off while said instrument is in the energized state but not in the measurement state;
means for enabling a measurement state; and
means operable for quickly turning on all view functions under control of said measurement enabling means.

11. A method for reducing the turn-on time of a measurement instrument comprising:
placing at least one processor subsystem within said measurement instrument into a boot state when said measurement instrument is energized; and
transitioning said processor subsystem into a sleep state if a power-on condition is not present from said boot state.

12. The method of claim 11 further comprising:
transitioning said processor subsystem to a power-on state from said sleep state when said power-on condition is present.

13. The method of claim 11 further comprising:
transitioning said processor subsystem to a sleep state while said instrument is still energized and said power-on condition is turned off.

14. The method of claim 11 further comprising:
transitioning said processor subsystem into a reboot state while said instrument is still energized and said power on condition is turned off.

15. The method of claim 11 further comprising:
turning on said instrument's display if said instrument's on-off switch is on and turning off said instrument's display if said instrument's on-off switch is off while said processor subsystem is in said boot state.

16. The method of claim 14 further comprising:
turning on said instrument's display if said instrument's on-off switch is on and turning off said instrument's display if said instrument's on-off switch is off while said processor subsystem is in said reboot state.

17. The method of claim 11 further comprising:
decreasing said processor subsystem's clock speed if said instrument's on-off switch is off and increasing said processor subsystem's clock speed if said instrument's on-off switch is on while said processor subsystem is in said boot state.

18. The method of claim 14 further comprising:
decreasing said processor subsystem's clock speed if said instrument's on-off switch is off and increasing said processor subsystem's clock speed if said instrument's on-off switch is on while said processor subsystem is in said reboot state.

19. The method of claim 14, wherein said reboot state comprises:
closing all programs and applications running on said processor subsystem's OS;
shutting down said processor subsystem's OS; and
restarting said processor subsystem's OS.

20. The method of claim 14, wherein said reboot state comprises:
removing power from said processor subsystem;
restoring power to said processor subsystem; and
starting said processor subsystem's OS.
